(19) United States
(12) Patent Application Publication
(10) Pub. No.: US 2012/0187089 A1
(43) Pub. Date: Jul. 26, 2012

(54) HIGH-VOLTAGE, SUPER-VOLTAGE AND HEAVY CURRENT BREAKER

(76) Inventors: Xuanshu Chen, Wuhan (CN); Yuan Pan, Wuhan (CN); Fei Liu, Wuhan (CN); Junjia He, Wuhan (CN); Zhao Yuan, Wuhan (CN); Ting Yin, Wuhan (CN); Yan Du, Wuhan (CN); Yan He, Wuhan (CN)

(21) Appl. No.: 13/393,225

(22) PCT Filed: Oct. 27, 2009
(86) PCT No.: PCT/CN2009/001198

§ 371 Date: Feb. 28, 2012

(30) Foreign Application Priority Data
Oct. 27, 2008 (CN) 200810197399.1

(51) Int. Cl. H01H 33/14

(52) U.S. Cl. 218/2

(57) ABSTRACT

A high-voltage, super-voltage and heavy current breaker is formed by combining intelligent optical vacuum breaker modules (21) with phase selection function in series and/or parallel connection. Each vacuum breaker module (21) is connected each other in series after being connected in parallel with a resistance capacitance device or with a resistance capacitance device and a zinc oxide arrester valve plate (22). Tight coupling reactors are connected with several serial branches of the vacuum breaker module (21) simultaneously to achieve parallel connection of several serial branches of the vacuum breaker module (21). The breaker distributes the high-voltage and heavy current into the low voltage and low current serial and parallel vacuum breaker modules (21) to share.

### FIELD OF THE INVENTION

The invention relates to a circuit breaker for high voltage (HV) & extra high voltage (EHV), and more particularly to a circuit breaker for HV & EHV and high current comprising intelligent fiber-controlled vacuum circuit breaker modules having phase selection function connected in series and/or in parallel. It belongs to power protection equipment technology.

### BACKGROUND OF THE INVENTION

In various possible power system faults, short-circuit fault, with high occurrence, has become a major factor to damage power system stability and power equipment or cause a large-scale blackout. In addition, since capacity expansion and interconnection make power system structure more complicated, therefore short-circuit capacity and short-circuit current become increasingly higher. When short-circuit current is higher than a breaker's interrupting capacity, it may result in failure of the breaker to effectively interrupt a fault, which would seriously threaten the safety operation of power equipment or even a whole power system. At present in China, short-circuit level of some nodes of the electricity transmission network has exceeded 100 kA and short-circuit current of a generator outlet has become higher and higher. For example, short-circuit current of a 300 MW power unit may reach 128.7-194.7 kA, 600 MW unit 180 kA and a Three Gorges Dam's power unit may even be up to 315 kA. Because the interrupting capacity of domestically manufactured breakers is far from meeting the requirements and imported breakers have limited application in Chinese power plants due to the price. Consequently, circuit breakers have become the main technical bottlenecks restricting the development of power industry.

SF₆ breakers, having been widely used in HV & EHV and high current (HC) applications, are now being gradually restricted as a result of environmental protection reasons. Vacuum is then regarded as an ideal insulating and arc-extinguishing medium to replace SF₆, however, as vacuum has its own unique characteristics, it is only used in medium-and low-voltage applications for the present. Furthermore, due to the limitation of technology and processing techniques, nominal current and nominal short-circuit current of vacuum circuit breakers cannot be improved dramatically, they are limited in HV and HC applications.

In addition, along with enlargement of system size and capacity, fault current and internal overvoltage increases. Conventional switch operations easily cause system instability, and users have imposed higher requirements on power quality. According to different load characteristics, phase selection switching technology enables the breaker to close and open when current and voltage are in the most favorable phase. In this way, it can actively eliminate electromagnetic transient effects caused by inrush current and overvoltage at the time of opening/closing process or prevent system instability. However, as conventional HV and HC circuit breakers have long contact gaps, large mass of moving contacts, long switching time and large dispersion, it is difficult to achieve rapid and accurate phase selection control in switching operations.

### SUMMARY OF THE INVENTION

In view of the above-described problems, it is one objective of the invention to provide a circuit breaker that can be used in HV and HC systems for rapid and accurate phase selection switching operations in interrupting fault current.

To achieve the above objectives, in accordance with one embodiment of the invention, there is provided a circuit breaker comprising intelligent fiber-controlled vacuum circuit breaker modules having phase selection function connected in series and/or in parallel.

In a class of this embodiment, each of the vacuum circuit breaker modules comprises a low potential unit of intelligent phase selection controller, a high potential unit of intelligent phase selection controller, a power drive unit, a power supply system, a permanent magnet actuator, a vacuum arc-extinguishing chamber, and an external insulation system. The low potential unit of intelligent phase selection controller, high potential unit of intelligent phase selection controller, power drive unit, and permanent magnet actuator are electrically connected in turn; a static contact, a moving contact, and a break spring are mounted inside the vacuum arc-extinguishing chamber; the moving contact is directly connected with a drive rod of the permanent magnet actuator; the power supply system is electrically connected with the power drive unit and comprises current energy extraction, voltage energy extraction, and low-order energy delivery; and the vacuum arc-extinguishing chamber is enclosed by the external insulation system.

In a class of this embodiment, the high/low potential unit of intelligent phase selection controller is equipped with a digital signal processor.

In a class of this embodiment, the high and the low potential unit of intelligent phase selection are connected using an optical control interface.

In a class of this embodiment, an independent permanent magnet actuator is used for each phase of the three-phase vacuum circuit breaker.

In a class of this embodiment, each of the vacuum circuit breaker modules is connected in series after it connects in parallel with a resistor-capacitor unit or a resistor-capacitor unit and a zinc-oxide arrestor valve plate.

In a class of this embodiment, multiple series branches of the vacuum circuit breaker modules are simultaneously connected with a tightly coupled reactor so that multiple series branches of the vacuum circuit breaker modules achieve parallel connection.

Working principle of the invention: in each vacuum circuit breaker module, after the computer system in power station sends action instructions, the low potential unit of intelligent phase selection controller will calculate optimal opening/closing phase according to three-phase voltage/current signals on power grid picked from a voltage transformer and a current transformer, and meanwhile continuously adjust offset parameters of opening/closing time to calculate required instructions to be sent after time delay according to vacuum circuit breaker status information (e.g., switch position, control voltage, and ambient temperature), sent by optical control interface and acquired in real-time by the high potential unit of intelligent phase selection controller and according to a switch position sensor, a control voltage sensor, and an ambient temperature sensor of the high potential unit of intelligent phase selection controller. When the high potential unit of intelligent phase selection controller receives operation instructions sent through the optical control interface, it will send opening and closing signals to the power drive unit, which will charge the charging/discharging coil of the permanent magnet actuator under the control of the high potential unit of intelligent phase selection controller to achieve opening/closing operations of the vacuum circuit breaker on the basis of reliable power supply of the power supply system. After the vacuum circuit breaker stops action, the low potential unit of intelligent phase selection controller will record the operation results and send back vacuum circuit breaker status information and operation results to the computer system in power station.

Advantages of the invention are summarized below.

1. HV and HC are distributed to each relatively low voltage and low current vacuum circuit breaker module in series or in parallel. As this type of structure is helpful to largely improve working voltage rating, current carrying capacity and interrupting capacity of individual vacuum arc-extinguishing chamber, the vacuum circuit breaker can be applied in HV and HC system.

2. Since each vacuum circuit breaker module has a small mass of moving contact and short distance, consequently opening/closing time and full stroke movement time of a contact are short, time dispersion is small, opening/closing time can be accurately predicated and controlled, rapid and accurate phase selection switching operations is achievable on each independent actuator. It will fundamentally change inrush current and overvoltage characteristics at the time when power system is in opening/closing operations, and meanwhile phase selection function is able to dramatically improve interrupting capacity of the switch.

3. Based on accurate phase selection operations of every vacuum circuit breaker module, the HV & EHV high current circuit breaker formed in series or in parallel, by means of paralleling the resistor-capacitor unit with the zinc-oxide arrestor valve plate or tightly coupled reactor technology, is able to achieve intelligent phase selection switching operations in fault current interrupting.

### BRIEF DESCRIPTION OF THE DRAWINGS

FIG. 1 a working principle diagram of an individual vacuum circuit breaker module according to an embodiment of the invention;

FIG. 2 a schematic diagram of a permanent magnet actuator and a vacuum arc-extinguishing chamber of FIG. 1;

FIG. 3 dual-pressure structure diagram formed by a resistor-capacitor unit and a zinc-oxide arrestor valve plate according to an embodiment of the invention;

FIG. 4-1 a schematic diagram of an individual HV high current circuit breaker;

FIG. 4-2 a working principle diagram of multiple vacuum circuit breaker modules according to an embodiment of the invention;

FIG. 5 a working principle diagram of a power drive unit and a power supply with current energy extraction method according to FIG. 1;

FIG. 6 a working principle diagram of a power supply with voltage energy extraction method according to FIG. 1;

FIG. 7 a working principle diagram of a power supply with low-order energy delivery method according to FIG. 1; and

FIG. 8 is a flow chart of a low potential unit of intelligent phase selection controller according to FIG. 1.

### DETAILED DESCRIPTION OF THE EMBODIMENTS

The invention is explained in further detail below with the aid of the example and attached drawings.

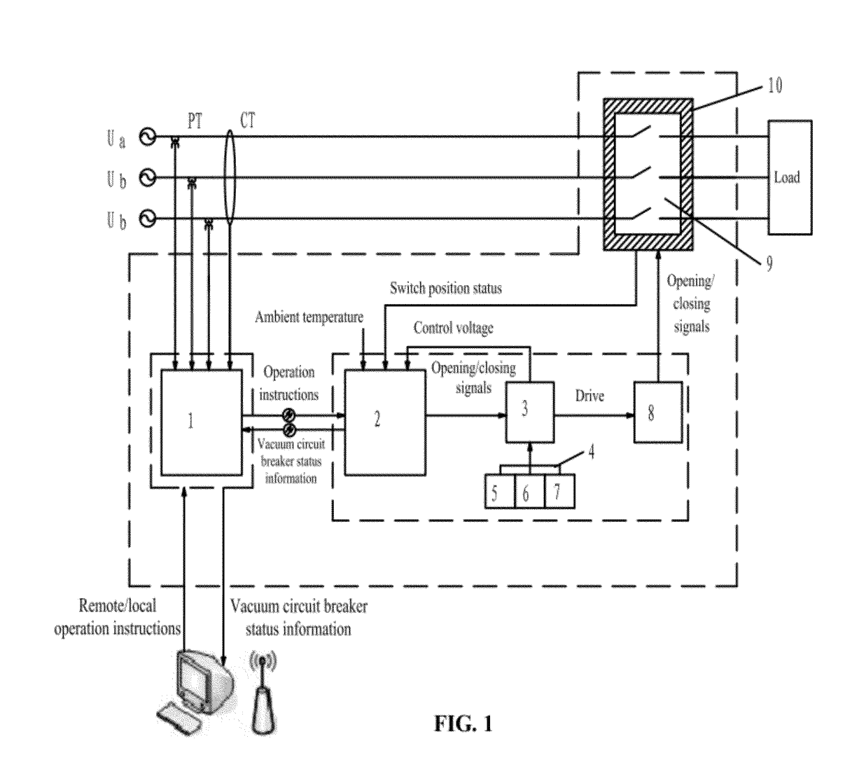

FIG. 1 shows a low potential unit of intelligent phase selection controller 1, a high potential unit of intelligent phase selection controller 2, a power drive unit 3, a power supply system 4, current energy extraction 5, voltage energy extraction 6, low-order energy delivery 7, a permanent magnet actuator 8, a vacuum arc-extinguishing chamber 9, an external insulation system 10, voltage transformer PT, and current transformer CT.

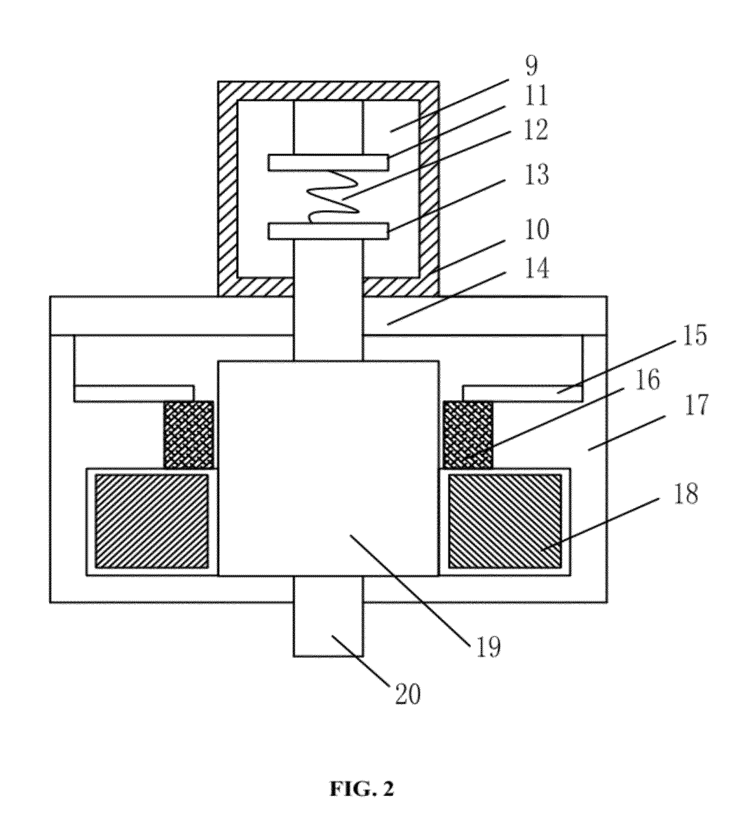

FIG. 2 shows a static contact 11, a break spring 12, a moving contact 13, a cover board 14, a magnetic guide ring 15, a permanent magnet 16, a static iron core 17, a charging/discharging coil 18, a moving iron core 19, and a drive rod 20.

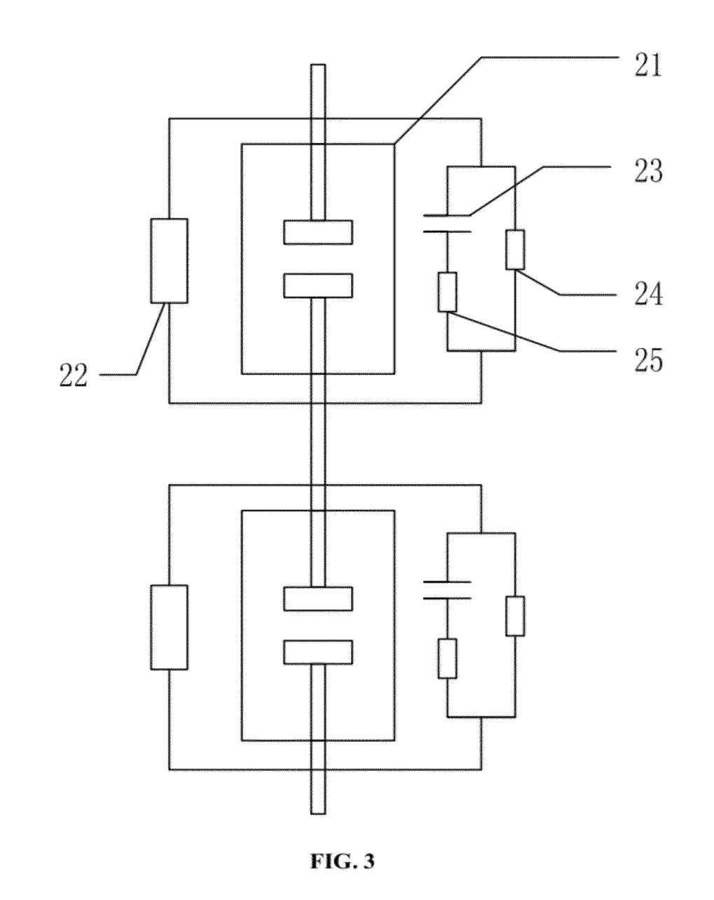

FIG. 3 shows a vacuum circuit breaker module 21, a zinc-oxide arrestor valve plate 22, a capacitor C 23, a resistance R₂ 24, and a resistance R₁25.

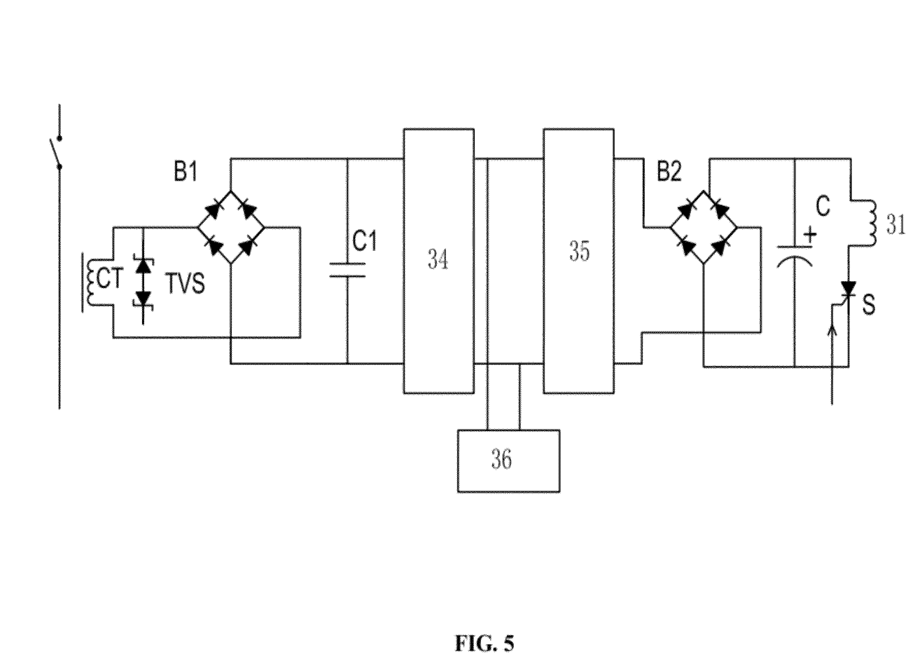

FIG. 5 shows a transient voltage suppressor (TVS), rectifier bridge B1/B2, filter capacitor C1, energy storage capacitor C, high-power controllable thyristor S, a charging/discharging coil 31, a voltage stabilizer circuit 34, an inverter circuit 35, and battery 36.

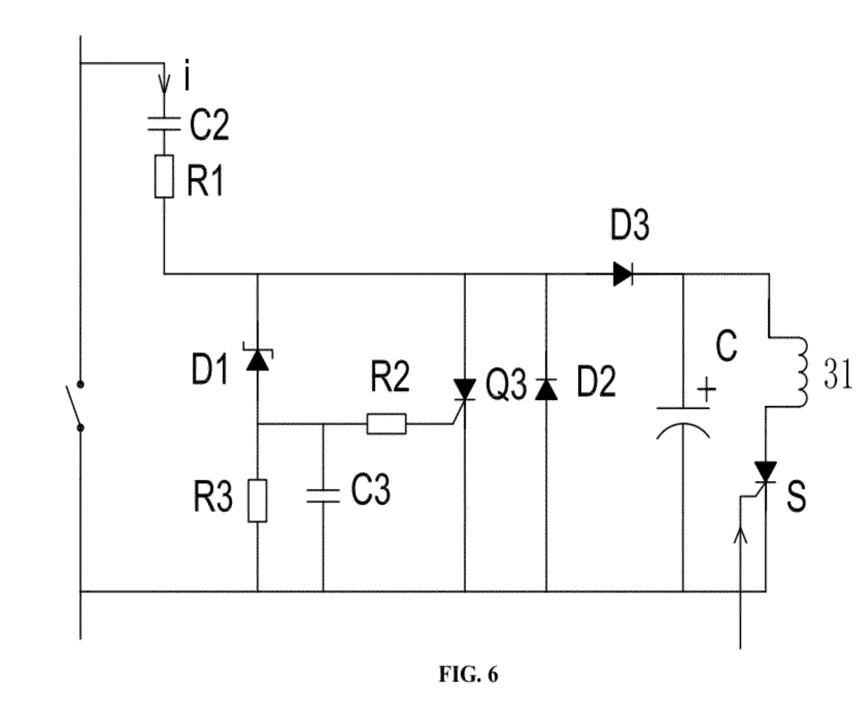

FIG. 6 shows resistances R1/R2/R3, voltage stabilizing diode D1/D2/D3 filter capacitors C2/C3, thyristor Q3, and current direction i.

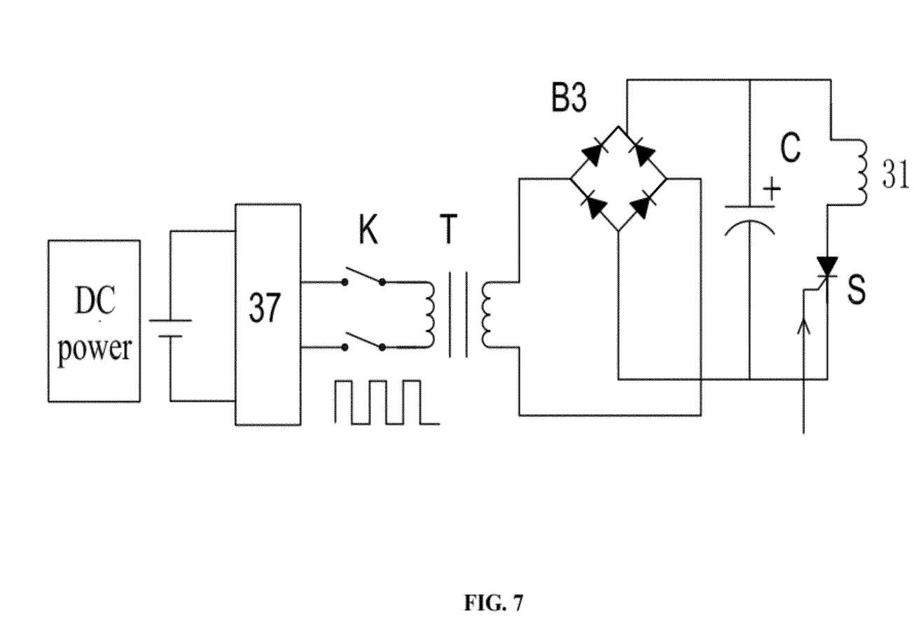

FIG. 7 show an invertor 37, switch K, magnetic ring T, and rectifier bridge B3.

In FIG. 1, a working principle diagram of an individual vacuum circuit breaker module comprises a low potential unit of intelligent phase selection controller 1, a high potential unit of intelligent phase selection controller 2, a power drive unit 3, a power supply system 4, a permanent magnet actuator 8, a vacuum arc-extinguishing chamber 9, and an external insulation system 10. The low potential unit of intelligent phase selection controller 1, the high potential unit of intelligent phase selection controller 2, the power drive unit 3, the permanent magnet actuator 8, and the vacuum arc-extinguishing chamber 9 are connected in turn while the power supply system 4, connected with the power drive unit 3, comprises current energy extraction 5, voltage energy extraction 6, and low-order energy delivery 7. The vacuum arc-extinguishing chamber 9 is enclosed by the external insulation system 10.

The low potential unit of intelligent phase selection controller 1 receives remote/local operation instructions sent by the computer system in power station and sends back vacuum circuit breaker status information, and meanwhile picks up three-phase voltage/current signals on power grid from voltage transformer PT and current transformer CT.

The high potential unit of intelligent phase selection controller 2 sends collected vacuum circuit breaker status information comprising switch position status, control voltage and ambient temperature to the low potential unit of intelligent phase selection controller 1. After the high potential unit of intelligent phase selection controller 2 receives operation instructions sent by the low potential unit of intelligent phase selection controller 1, it will send opening/closing signals to the power drive unit 3, and the power drive unit 3, which is connected with the power supply system 4, will then drive the permanent magnet actuator 8 to achieve opening/closing operations of the vacuum circuit breaker.

Both the low potential unit of intelligent phase selection controller 1 and the high potential unit of intelligent phase selection controller 2 use digital signal processor (DSP processor), and optical control interface is adopted for signal transmission between the two. Each phase of the three vacuum circuit breaker phases is equipped with an independent permanent magnet actuator 8.

The permanent magnet actuator 8 is a monostable permanent magnet actuator. As shown in FIG. 2, the vacuum arc-extinguishing chamber 9 comprises the static contact 11, the break spring 12, and the moving contact 13. The monostable permanent magnet actuator 8 comprises the cover board 14, the magnetic guide ring 15, the permanent magnet 16, the static iron core 17, the charging/discharging coil 18, the moving iron core 19, and the drive rod 20.

The break spring 12 is connected between the static contact 11 and the moving contact 13; the drive rod 20, connected with the moving iron core 19, is also connected with the moving contact 13 of the vacuum arc-extinguishing chamber 9; the upper side of the static iron core 17 is fixed with the non-magnetic cover board 14; the upper side and the lower side of the permanent magnet 16 is connected with the magnetic guide ring 15 and the charging/discharging coil 18 respectively. The opening/closing operations are achieved by the same charging/discharging coil 18 through current in different directions: closing status is maintained by magnetic force while opening status is maintained by the break spring 12. Switch opening is accomplished by means of releasing the energy of the break spring 12 with high opening speed; as the monostable permanent magnet actuator 8 has few parts but with only one moving iron core 19 in its moving element, the mechanical lifespan and reliability improves considerably; the monostable permanent magnet actuator 8 and the vacuum arc-extinguishing chamber 9 are at the same high potential with simplified insulation; sine the same charging/discharging coil 18 applies to the opening/closing operations, it has greater advantages such as compact and maintenance free; small action time dispersion helps to realize independent phase separation operations.

Series technology in multiple vacuum circuit breaker modules: each series vacuum circuit breaker module 21 (simplified diagram) is the intelligent fiber-controlled vacuum circuit breaker module with three separate phases, able to accomplish phase selection switching operations according to FIG. 1 and FIG. 2. At both ends of the incoming/outgoing wire of an individual vacuum circuit breaker module 21 are connected in parallel with the resistor-capacitor unit and zinc-oxide arrestor valve plate 22, as shown in FIG. 3, the resistor-capacitor unit comprises the capacitor C 23, small series resistance R₁ 25 and big parallel resistance R₂ 24. When current in the vacuum arc-extinguishing chamber 9 quenches, series branches of the capacitor C 23 and the resistance R₁ 25 perform pressure equalizing function and the resistance R₁ 25 will restrict the current passing through the capacitor C 23 under transient conditions; the resistance R₂ 24 is connected in parallel with series branches of the capacitor C 23 and the resistance R₁ 25 to form a loop, which is used to release electric energy stored in the capacitor C 23 under transient conditions. Both ends of an individual vacuum circuit breaker module 21 are connected in parallel with a zinc-oxide arrestor valve plate 22 each at the same time, which is used to collect an arrester's residual voltage and restrict recovery voltage amplitude of the vacuum circuit breaker so as to reduce the possibility for reburn or restrike and achieve reliable series operations of multiple vacuum circuit breaker modules 21.

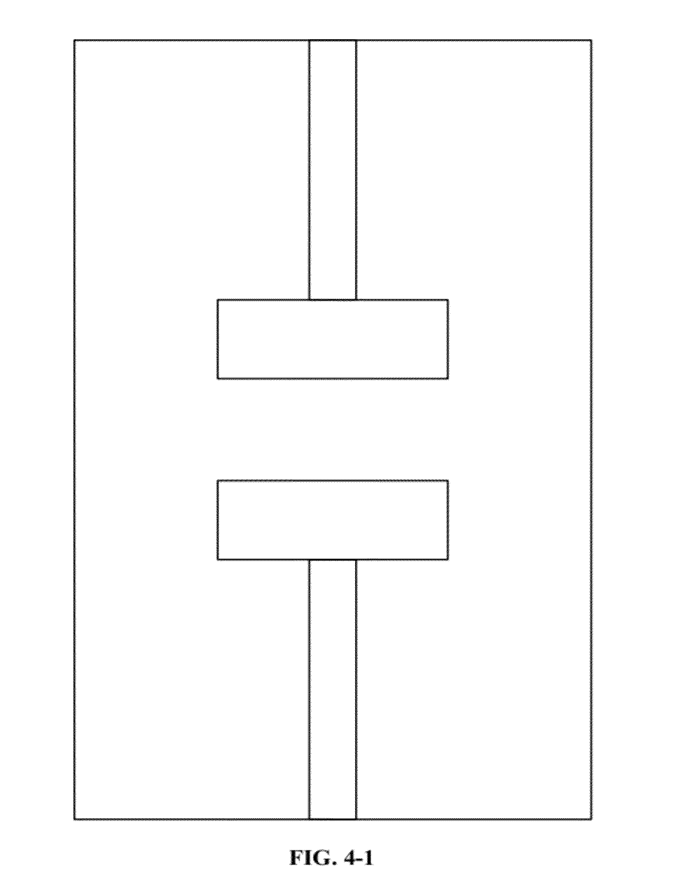

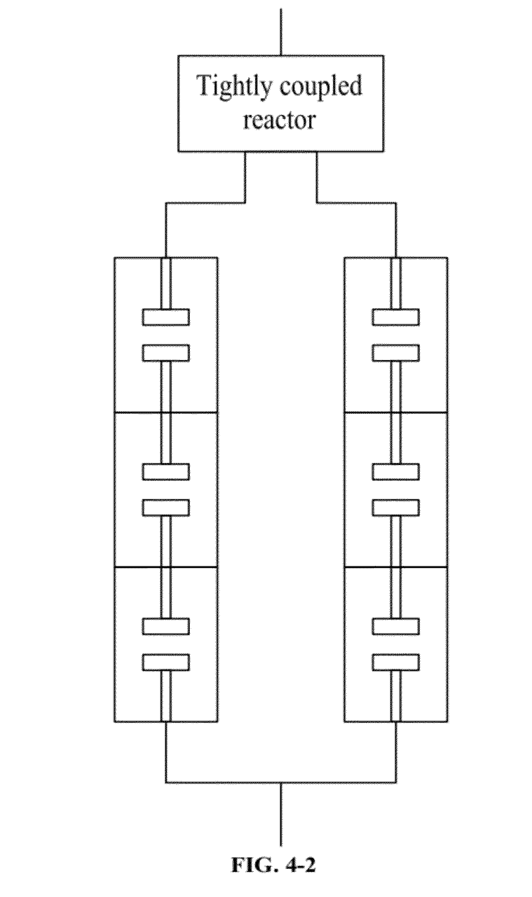

In FIG. 4-2, based on series connection of the multiple vacuum circuit breaker modules 21 as shown in FIG. 3, connect a tightly coupled reactor with outgoing wire of the vacuum circuit breaker formed by two groups of the multiple vacuum circuit breaker modules 21. It will operate in parallel through automatic current sharing and limiting so as to create a HV & EHV high current circuit breaker formed in series or in parallel by multiple vacuum circuit breaker modules 21.

Compared with individual HV high current circuit breaker as shown in FIG. 4-1, each vacuum circuit breaker module 21 as shown in FIG. 4-2 has small mass of the moving contact 13 and short distance, consequently opening/closing time and full stroke movement time of the moving contact 13 are short, time dispersion is small, opening/closing time can be accurately predicated and controlled; since every vacuum circuit breaker module 21 can achieve accurate phase selection switching operations based on each independent permanent magnet actuator 8, thus through reasonable communication design of the module 21, phase selection switching function of each module 21 will be featured in HV & EHV high current circuit breaker connected in series or in parallel.

Working principle of the power drive unit 3 of FIG. 1 is shown in FIG. 5, the current transformer CT, transient voltage suppressor TVS, rectifier bridge B1, filter capacitor C1, voltage stabilizer circuit 34, inverter circuit 35, rectifier bridge B2, and energy storage capacitor C are electrically connected in turn; the charging/discharging coil 31 connects in parallel with the energy storage capacitor C after it connects with the high-power controllable thyristor S in series; the inverter circuit is connected with an battery 36.

The power supply system 4 charges the energy storage capacitor C all the time. When high-power controllable thyristor S receives opening/closing signals sent by the high potential unit of intelligent phase selection controller 2, the fully charged energy storage capacitor C will discharge the charging/discharging coil 31 in the monostable permanent magnet actuator 8 in order to generate pulsed magnetic field to drive the iron core 32 to move.

In FIG. 5, the power supply system 4 directly adopts current energy extraction method from HV bus. When the vacuum circuit breaker is in closing status, the current transformer CT will directly extract energy from power grid's load current, then transform it into low-voltage DC source through transient voltage suppressor TVS, rectifier bridge B1, filter capacitor C1 and voltage stabilizer circuit 34, and finally charge the energy storage capacitor C through inverter circuit 35 and rectifier bridge B2. When the vacuum circuit breaker is in opening status or in system no-load status, the current transformer CT will be unable to directly extract energy from power grid current, therefore a battery 36 is required to be mounted in the front of the inverter circuit 35. The low-voltage DC source, after passing through the voltage stabilizer circuit 34, will charge the battery 36 under constant voltage and floating conditions. If current energy extraction fails, the battery 36 will then charge the energy storage capacitor C through inverter circuit 35 and rectifier bridge B2.

Working principle of voltage energy extraction shown in FIG. 6 according to FIG. 1, in order for the vacuum circuit breaker to have power supply under long-term opening status, voltage energy extraction power is also employed. When voltage is in positive semicircle, the current i has the direction as shown in the diagram and the energy storage capacitor C will be charged through the filter capacitor C2, resistance R1 and voltage stabilizing diode D3. When terminal voltage of the energy storage capacitor C exceeds amplitude value of voltage stabilizing diode D1, thyristor Q3 will be on and voltage stabilizing diode D3 will be off and charging to the energy storage capacitor C will be stopped. When terminal voltage of the energy storage capacitor C remains the same as the amplitude value, the energy in the energy storage capacitor C is the working power.

When power-off time of both sides of the vacuum circuit breaker is too long and when current/voltage energy extraction methods fail and battery power is insufficient, low-order energy delivery method can be adopted. The working principle of low-order energy delivery method as shown in FIG. 7 according to FIG. 1, any DC power at earth potential will be transformed into high-frequency current source through the invertor 37. According to electromagnetic induction principle, the energy at earth potential will be sent to high-voltage side through magnetic loop T. High-frequency power acquired through the magnetic loop T will be used to charge the energy storage capacitor C through filtering, voltage stabilizing and rectifier bridge B3. When the energy storage capacitor C has been fully charged, turn off the switch K to stop charging.

Example: after the computer system in power station sends action instructions, the low potential unit of intelligent phase selection controller 1 will calculate optimal opening/closing phase according to three-phase voltage/current signals on power grid picked from voltage transformer PT and current transformer CT, and meanwhile continuously adjust offset parameters of opening/closing time to calculate required instructions to be sent after time delay according to vacuum circuit breaker status information (e.g. switch position, control voltage and ambient temperature), sent by optical control interface and acquired in real-time by the high potential unit of intelligent phase selection controller 2 and according to switch position sensor, control voltage sensor and ambient temperature sensor; when the high potential unit of intelligent phase selection controller 2 receives operation instructions sent through the optical control interface, it will send opening/closing signals to the power drive unit 3, which will charge the charging/discharging coil 31 of the permanent magnet actuator 8 under the control of the high potential unit of intelligent phase selection controller 2 so as to achieve opening/closing operations of the vacuum circuit breaker on the basis of reliable power supply of the power supply system 4. After the vacuum circuit breaker stops action, the low potential unit of intelligent phase selection controller 1 will record the operation results and send back vacuum circuit breaker status information and operation results to the computer system in power station.

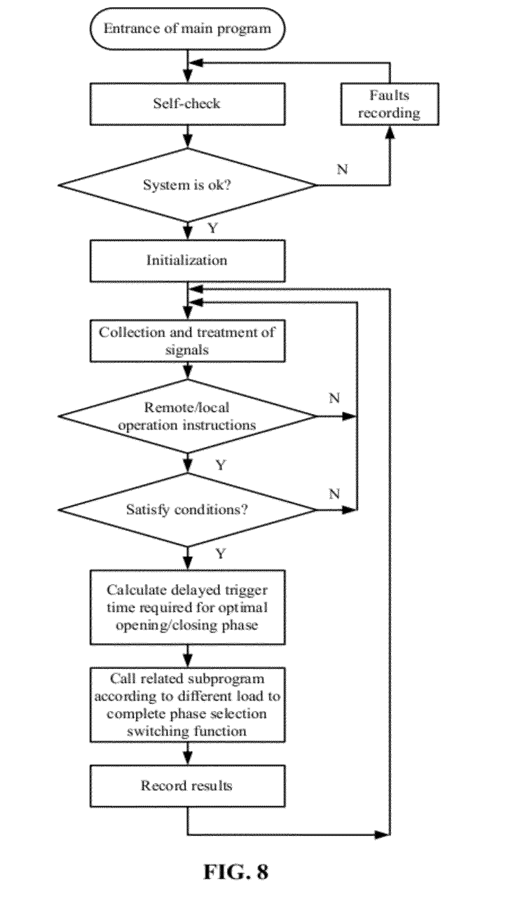

FIG. 8 is a flow chart of the low potential unit of intelligent phase selection controller 1 according to FIG. 1. To ensure normal working of the control system, self-check must be carried out at start-up stage. After the system passes self-check, the program will be in initialization phase comprising setup of DSP control register and initialization of timer and internal data memory. If the system fails to receive local/remote instructions, the following work will be completed comprising power grid parameters collection, control voltage and ambient temperature monitoring, and data upload to the computer system in power station. If the system successfully receives local/remote instructions through multiple communication interfaces, inspect whether opening/closing status information, i.e. control voltage, ambient temperature and switch contact position meet opening/closing conditions. As a result, the system will calculate delayed trigger time required for optimal opening/closing phase and call related subprogram according to different load to complete phase selection switching function and then record related results.

The invention is also characterized in that after both ends of incoming/outgoing wire of an individual vacuum circuit breaker module are connected in parallel with the resistor-capacitor unit, the pressure of upper/lower vacuum arc-extinguishing chamber will be further distributed evenly. Meanwhile, after it is also connected in parallel with the zinc-oxide arrestor valve plate, the valve plate will action first to restrict voltage recovery of vacuum arc-extinguishing chamber contacts when some vacuum arc-extinguishing chamber undertakes higher recovery voltage during the process of dielectric recovery. In this way, it can prevent the vacuum arc-extinguishing chamber from reburn or restrike so that multiple vacuum arc-extinguishing chambers will complete opening/closing process together. In contrast, the series vacuum circuit breaker module with pressure evenly distributed by the resistor-capacitor unit is able to further reduce the vacuum arc-extinguishing chamber restrike times and improve interrupting capacity of the series vacuum circuit breaker under the uniform pressure effect of the zinc-oxide arrestor valve plate.

The series vacuum circuit breaker module branches, connected through tightly coupled reactor, will achieve parallel operations. The tightly coupled reactor, with small impedance and power, ensures that the current is evenly distributed in parallel branches under normal working conditions; If multiple vacuum circuit breaker modules have inconsistent actions, when the vacuum circuit breaker module with first action quenches arc, the tightly coupled reactor, now with high current-limiting reactance, will work at automatic current limiting status to restrict the fault current. Consequently vacuum circuit breaker module after breaking can independently complete fault current interrupting and parallel operations of multiple series vacuum circuit breaker modules are achieved.

The invention claimed is:

1. A circuit breaker comprising intelligent fiber-controlled vacuum circuit breaker modules having phase selection function connected in series and/or in parallel.

2. The circuit breaker of claim 1, wherein
each of said vacuum circuit breaker modules comprises a low potential unit of intelligent phase selection controller, a high potential unit of intelligent phase selection controller, a power drive unit, a power supply system, a permanent magnet actuator, a vacuum arc-extinguishing chamber, and an external insulation system;
said low potential unit of intelligent phase selection controller, high potential unit of intelligent phase selection controller, power drive unit, and permanent magnet actuator are electrically connected in turn;
a static contact, a moving contact, and a break spring are mounted inside said vacuum arc-extinguishing chamber;
said moving contact is directly connected with a drive rod of said permanent magnet actuator;
said power supply system is electrically connected with said power drive unit and comprises current energy extraction, voltage energy extraction, and low-order energy delivery; and
said vacuum arc-extinguishing chamber is enclosed by said external insulation system.

3. The circuit breaker of claim 2, wherein said high/low potential unit of intelligent phase selection controller is equipped with a digital signal processor.

4. The circuit breaker of claim 2, wherein said high and said low potential unit of intelligent phase selection are connected using an optical control interface.

5. The circuit breaker of claim 2, wherein an independent permanent magnet actuator is used for each phase of the three-phase vacuum circuit breaker.

6. The circuit breaker of claim 1 or 2, wherein each of said vacuum circuit breaker modules is connected in series after being connected in parallel with a resistor-capacitor unit or a resistor-capacitor unit and a zinc-oxide arrestor valve plate.

7. The circuit breaker of claim 1 or 2, wherein multiple series branches of said vacuum circuit breaker modules are simultaneously connected with a tightly coupled reactor so that multiple series branches of said vacuum circuit breaker modules achieve parallel connection.
